(19) United States
(12) Patent Application Publication
(10) Pub. No.: US 2020/0218134 A1
(43) Pub. Date: Jul. 9, 2020

(54) FLASH DEVICE SYSTEM

(71) Applicant: PROFOTO AKTIEBOLAG, Sundbyberg (SE)

(72) Inventors: Emil STENBACKA, Stockholm (SE); Johan ANSÉHN, Stockholm (SE)

(21) Appl. No.: 16/647,455

(22) PCT Filed: Sep. 17, 2018
(86) PCT No.: PCT/SE2018/050944

§ 371 Date: Mar. 13, 2020

(30) Foreign Application Priority Data
Sep. 18, 2017 (SE) 1751150-2

(51) Int. Cl. F21K 5/06; G03B 15/05; H01M 2/10; H01M 2/34; H02J 7/00

(52) U.S. Cl. CPC G03B 15/0447; G03B 15/05; H02J 7/0045; H01M 2/342; H01M 2/1022

(57) ABSTRACT

A flash device system for photographic purposes includes: a flash holder having a battery accommodating cavity formed therein; a flash housing hinged onto the flash holder; and a battery, wherein the battery accommodating cavity includes: electrical access contacts; a battery locking protruding element; and a battery locking cavity, wherein the battery locking protruding element and the battery locking cavity are arranged on opposite inner side walls of the battery accommodating cavity and, wherein the battery comprises: electric contacts for engagement with the electrical access contacts in the battery accommodating cavity; a cavity locking protruding element and a cavity locking cavity for engagement with the corresponding battery locking protruding element and battery locking cavity in the battery accommodating cavity. The flash device system can also include a battery charger.

### TECHNICAL FIELD

The present disclosure relates to a flash device system, a flash device, a battery and a battery charger for photographic purposes.

### BACKGROUND ART

In order to be able to take photographs of a certain quality a flash device is often used to provide light to or to improve the light in the photograph. In order to be able to provide flashes a large amount of energy is needed. For small flash devices, such as portable flash devices attachable to a camera or other hand held flash devices, a battery is often used as the source of energy for providing flash light. Due to the large amount of energy stored within the battery, is it essential that the battery is safe. In addition, it is essential that the battery can be easily exchanged in order to provide a user friendly flash device for the user.

### SUMMARY

According to one embodiment, a flash device system for photographic purposes is provided. The flash device system comprises: a flash holder having a battery accommodating cavity formed therein; a flash housing hinged onto the flash holder; and a battery, wherein the battery accommodating cavity comprises: electrical access contacts; a battery locking protruding element; and a battery locking cavity. The battery locking protruding element and the battery locking cavity are arranged on opposite inner side walls of the battery accommodating cavity. The battery comprises: electric contacts for engagement with the electrical access contacts in the battery accommodating cavity; a cavity locking protruding element and a cavity locking cavity for engagement with the corresponding battery locking protruding element and battery locking cavity in the battery accommodating cavity.

According to one embodiment, the cavity locking protruding element and a cavity locking cavity and the battery locking protruding element and the battery locking cavity are exchanged for other fastening means, such as a magnetic fastening element or similar.

The flash device system enables a user friendly and safe flash device system wherein the user can easily place the battery in the battery accommodating cavity and wherein it is clearly visible to the user how the battery is supposed to be placed in the battery accommodating device. The flash device system provides for a simple and safe replacement of batteries when a battery needs to be exchanged. In addition, no flap or lid or other part has to be removed in order to reach the battery.

According to one embodiment the cavity locking protruding element and/or the cavity locking cavity of the battery comprises a spring loaded push button.

According to one embodiment the battery locking protruding element and/or the battery locking cavity or the battery accommodating cavity comprises a spring loaded push button,

By using a spring loaded push button in order to lock and/or release the battery in the flash device system, a user friendly and safe flash device system is achieved.

According to one embodiment an exterior surface of the battery forms an exterior surface of the flash holder when the battery is arranged in the battery accommodating cavity. This design of the battery and the flash holder enables a user friendly flash device system where it is visible for the user where the battery is arranged and the orientation of the battery which enables a quick and safe exchange of batteries when necessary. In addition, the design of the system is attractive.

According to one embodiment, two of the electric contacts of the battery are arranged to switch on the battery when put in contact with the corresponding electric contacts of the battery accommodating cavity.

The switching on of the battery can e.g. be achieved in that an internal electric switch device of the battery is activated when the two electric contacts of the battery are connected to a short circuit, for example such as can be provided by the electric contacts of the battery accommodating cavity or corresponding electric contacts. When the switch device is activated, electricity can be supplied from the battery to the other parts of the flash device system. Alternatively, electricity can be supplied to the battery if the battery is located in a battery charger as will be described later.

By only switching on the battery when two of the electric contacts of the battery are put in contact with corresponding electric contacts of a battery accommodating cavity, a safe flash device system is created where the risk of switching on the battery unintentionally is minimized.

According to one embodiment, the two electric contacts of the battery arranged to switch the battery on are arranged to be put in contact with the corresponding electric contacts of the battery accommodating cavity at the moment when the battery is locked into the battery accommodating cavity.

By not switching on the battery until the battery is locked into the battery accommodating cavity an even safer flash device system is created, where an unintentional switching on of the battery is prevented.

According to one embodiment, the battery/batteries is/are of Lithium-ion type.

According to one embodiment, a flash device for photographic purposes is provided. The flash device comprises: a flash holder having a battery accommodating cavity formed therein; and a flash housing hinged onto the flash holder; wherein the battery accommodating cavity comprises: electrical access contacts; a battery locking protruding element; and a battery locking cavity, wherein the battery locking protruding element and the battery locking cavity are arranged on opposite inner side walls of the battery accommodating cavity.

The flash device enables a user friendly and safe flash device wherein the user can easily place a battery in the battery accommodating cavity and wherein it is clearly visible to the user how the battery is supposed to be placed in the battery accommodating device. The flash device provides for a simple and safe replacement of batteries when a battery needs to be charged,

According to one embodiment the battery locking protruding element and/or the battery locking cavity of the flash device comprises a spring loaded push button.

By using a spring loaded push button in order to lock and/or release a battery to the flash device, a user friendly and safe flash device is achieved.

According to one embodiment two of the electric contacts of the battery accommodating cavity are arranged to switch on a battery placed in the battery accommodating cavity when put in contact with the corresponding electric contacts of the battery.

By not switching on the battery until the battery is locked into the battery accommodating cavity of the flash device creates an even safer device, where an unintentional switching on of the battery is prevented.

According to one embodiment, two of the electric contacts of the battery accommodating cavity of the flash device are arranged to switch on a battery placed in the battery accommodating cavity when put in contact with the corresponding electric contacts of the battery at the moment when the battery is locked into the battery locking cavity.

By not switching on the battery until the battery is locked into the battery accommodating cavity creates an even safer flash device, where an unintentional switching on of the battery is prevented.

According to one embodiment a battery for a flash device for photographic purposes is provided. The battery comprises: electric contacts; a cavity locking protruding element and a cavity locking cavity for engagement with a corresponding battery locking protruding element and battery locking cavity in a battery accommodating cavity.

According to one embodiment, the cavity locking protruding element and/or the cavity locking cavity of the battery comprises a spring loaded push button.

By using a spring loaded push button in order to lock and/or release the battery to a battery accommodating cavity, a user friendly and safe flash device system is achieved.

According to one embodiment two of the electric contacts of the battery are arranged to switch on the battery when put in contact with corresponding electric contacts of a battery accommodating cavity.

By only switching on the battery when two of the electric contacts of the battery are put in contact with corresponding electric contacts of a battery accommodating cavity, a safe battery is created where the risk of switching on the battery unintentionally is minimized.

According to one embodiment two of the electric contacts of the battery are arranged to switch on the battery when put in contact with the corresponding electric contacts of a battery accommodating cavity at the moment when the battery is locked into the battery locking cavity.

By not switching on the battery until the battery is locked into a battery accommodating cavity creates an even safer battery, where an unintentional switching on of the battery is prevented.

According to one embodiment, the battery/batteries is are of Lithium-ion type.

According to one embodiment a battery charger for a flash device for photographic purposes is provided. The battery charger comprises: a battery accommodating cavity comprising: electric access contacts; a battery locking protruding element and a battery locking cavity for engagement with a corresponding cavity locking protruding element and cavity locking cavity on a battery, wherein the battery locking protruding element and the battery locking cavity are arranged on opposite inner side walls of the battery accommodating cavity.

According to one embodiment the battery locking protruding element and/or the battery locking cavity element of the battery charger comprises a spring loaded push button.

By using a spring loaded push button in order to lock and/or release a battery to be attached to the battery charger, a user friendly and safe battery charger is achieved.

According to one embodiment, two of the electric contacts of the battery accommodating cavity of the battery charger are arranged to switch on a battery placed in the battery accommodating cavity when put in contact with the corresponding electric contacts of the battery.

By only switching on the battery when two of the electric contacts of the battery are put in contact with corresponding electric contacts of the battery accommodating cavity of the battery charger, a safe device is created.

According to one embodiment two of the electric access contacts of the battery accommodating cavity of the battery charger are arranged to switch on a battery placed in the battery accommodating cavity when put in contact with the corresponding electric contacts of the battery at the moment when the battery is locked into the battery accommodating cavity.

By not switching on the battery until the battery is locked into the battery accommodating cavity of the battery charger creates an even safer battery charger, where an unintentional switching on of the battery is prevented.

### BRIEF DESCRIPTION OF THE DRAWINGS

In the following description of embodiments of the proposed technique, reference will be made to the accompanying drawings of which:

FIG. 1 schematically illustrates a flash device system according to different embodiments.

FIG. 2a-c schematically illustrates a flash device according to different embodiments

FIG. 3a-c schematically illustrates battery for a flash device according to different embodiments

FIG. 4a-b schematically illustrates battery charger for a battery for a flash device according to different embodiments

### DETAILED DESCRIPTION

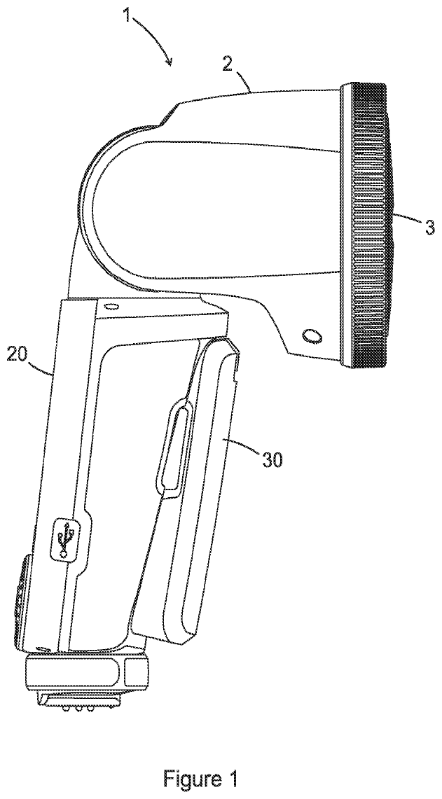

FIG. 1 illustrates a flash device system 1 according to one example. The flash device system 1 is arranged to be used for photographic purposes. According to one example, the flash device system 1 is arranged to be releasably attachable to a camera. The flash device system 1 comprises in the illustrated example a flash holder 20 and a flash housing 2 hinged onto the flash holder 20. The flash device further comprises a releasable battery 30, attached to the flash holder 20. The flash housing is equipped with a lens element 3 arranged to affect the generated flash light in a desired way. According to one embodiment, an exterior surface 40 of the battery 30 forms an exterior surface 40 of the flash holder 20 when the battery 30 is attached to the flash holder 20.

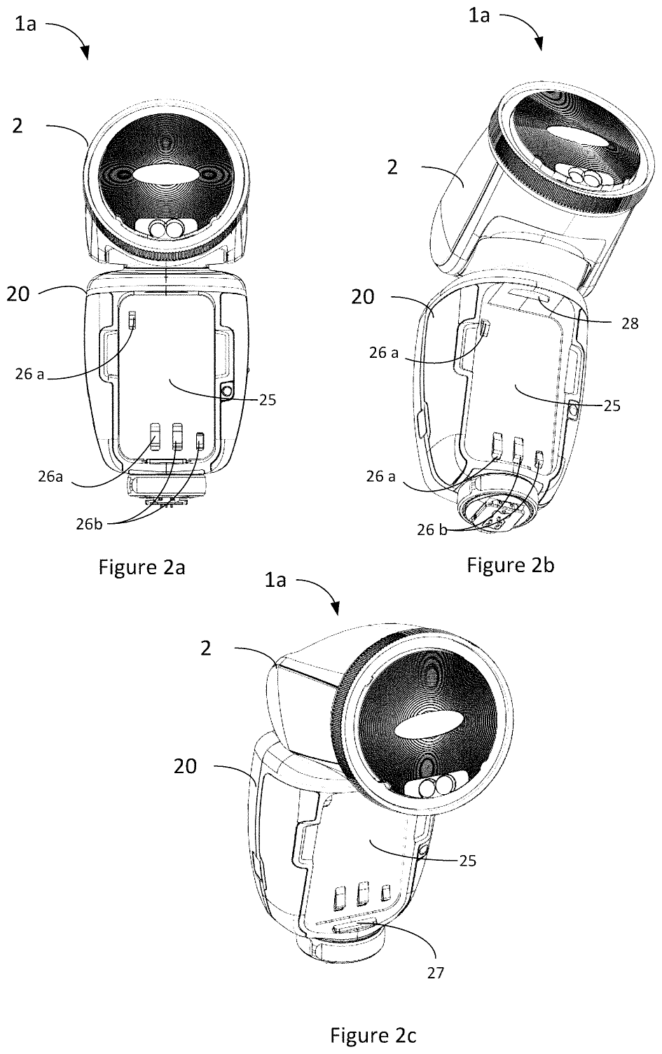

FIG. 2a-c illustrates a flash device 1a viewed from different angles. The flash device comprises a flash holder 20 having a battery accommodating cavity 25 formed therein and a flash housing 2 hinged onto the flash holder 20. The flash holder 20 comprises a battery accommodating cavity 25. The battery accommodating cavity 25 comprises electrical access contacts 26a, 26b; a battery locking protruding element 27; and a battery locking cavity 28. The battery locking protruding element 27 and the battery locking cavity 28 are arranged on opposite inner side walls of the battery accommodating cavity 25. The battery accommodating cavity 25 is arranged to accommodate a battery for the flash device 1a. According to one embodiment, the battery locking protruding element 27 and/or the battery locking cavity 28 comprises a spring loaded push button.

According to one embodiment, two of the electric contacts 26a of the battery accommodating cavity 25 are arranged to switch on a battery 30 placed in the battery accommodating cavity 25 when put in contact with the corresponding electric contacts of a battery 30 at the moment when the battery 30 is locked into a the battery accommodating cavity 25.

According to one embodiment not illustrated, the battery is attached to the battery accomodating cavity by means of magnetic engagement.

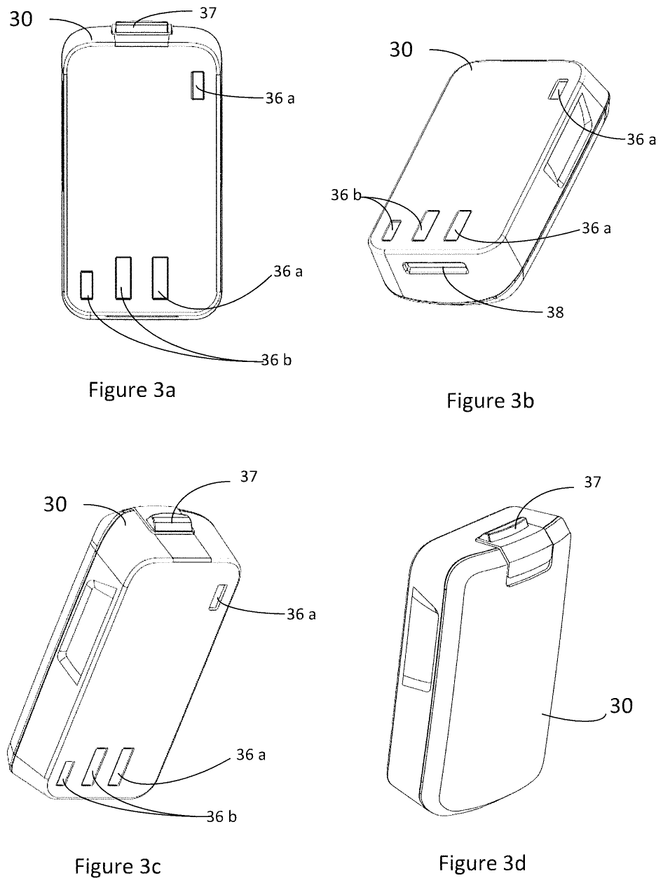

FIG. 3a-d illustrates a battery 30 for a flash device for photographic purposes viewed from different angles. The battery 30 comprises: electric contacts 36a, 36b; a cavity locking protruding element 37 and a cavity locking cavity 38 for engagement with a corresponding battery locking protruding element 27 and battery locking cavity 28 in a battery accommodating cavity 25. According to one embodiment, the cavity locking protruding element 37 and/or the cavity locking cavity 38 comprise a spring loaded push button. According to the illustrated embodiment, cavity locking protruding element 37 comprises a spring loaded push button. By pushing cavity locking protruding element 37, the battery may be released from for example a battery accommodating cavity 25 accommodated in the flash device 1a. In addition, the cavity locking protruding element 37 may be involved in locking the battery 30 into a battery accommodating cavity 25. As the battery is pushed into a battery accommodating cavity 25, the spring loaded cavity locking protruding element 37 is affected and when the battery 30 is in its final position in the battery accommodating cavity 25, the spring loaded cavity locking protruding element 37 springs back into its starting position, thereby locking the battery to the battery accommodating cavity 25.

According to one embodiment, two of the electric contacts 36a of the battery 30 are arranged to switch on the battery 30 when put in contact with corresponding electric contacts 26a of a battery accommodating cavity. By arranging two of the electric contacts 36a so that the battery 30 is switched on when the two electric contacts 36a are put in contact with corresponding electric contacts of a battery accommodating cavity, a safe battery is achieved, where the risk of accidentally starting the battery is reduced.

According to one embodiment, the battery 30 is of Lithium-ion type. According to one embodiment, two of the electric contacts 36a of the battery 30 are arranged to switch on the battery 30 when put in contact with the corresponding electric contacts 26a of a battery accommodating cavity 25, 45 at the moment when the battery 30 is locked into the battery accommodating cavity 25. By this construction, an even safer battery is achieved, wherein the risk of accidentally starting the battery is further reduced.

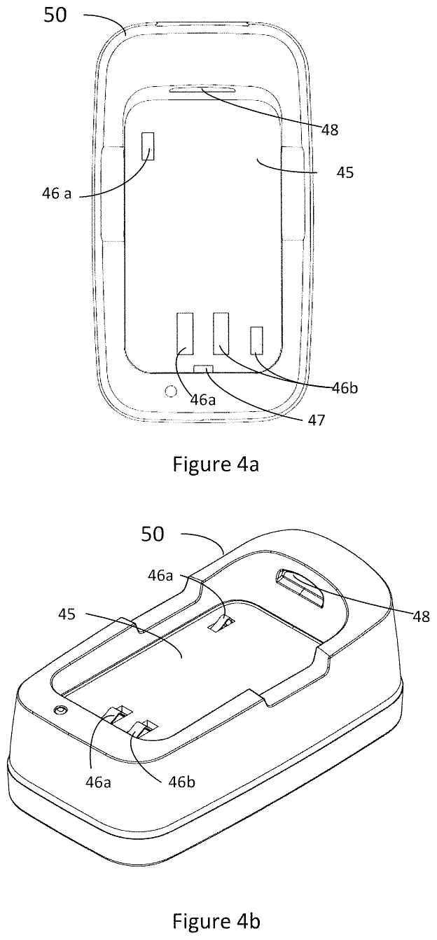

FIG. 4a-b illustrates a battery charger 50 for a battery 30 for a flash device for photographic purposes. The battery charger 50 comprises: a battery accommodating cavity 45 comprising electric access contacts 46a, 46b. The battery accommodating cavity 45 further comprises a battery locking protruding element 47 and a battery locking cavity 48 for engagement with a corresponding cavity locking protruding element 27 and cavity locking cavity 28 on a battery 30. The battery locking protruding element 47 and the battery locking cavity 48 are arranged on opposite inner side walls of the battery accommodating cavity 45. The battery locking protruding element 47 and/or the battery locking cavity element 48 comprises a spring loaded push button.

According to one embodiment, two of the electric access contacts 46a of the battery accommodating cavity 45 are arranged to switch on a battery 30 placed in the battery accommodating cavity 45 when put in contact with the corresponding electric contacts 36a of the battery 30.

By arranging two of the electric contacts 46a so that the battery 30 is switched on when the two electric contacts 46a are put in contact with corresponding electric contacts 36a of a battery 30, a safe battery charger 50 is achieved, where the risk of accidentally starting a battery 30 is reduced.

According to one embodiment, two of the electric access contacts 46a of the battery accommodating cavity 45 are arranged to switch on a battery 30 placed in the battery accommodating cavity 45 when put in contact with the corresponding electric contacts 36a of the battery 30 at the moment when the battery 30 is locked into the battery accommodating cavity 45.

By this construction, an even safer battery charger is achieved, wherein the risk of accidentally starting the battery is further reduced.

1. A flash device system for photographic purposes comprising:
a flash holder having a battery accommodating cavity formed therein;
a flash housing hinged onto the flash holder; and
a battery,
wherein the battery accommodating cavity comprises:
electrical access contacts;
a battery locking protruding element; and
a battery locking cavity,
wherein the battery locking protruding element and the battery locking cavity are arranged on opposite inner side walls of the battery accommodating cavity, and
wherein the battery comprises:
electric contacts for engagement with the electrical access contacts in the battery accommodating cavity; and
a cavity locking protruding element and a cavity locking cavity for engagement with the corresponding battery locking protruding element and battery locking cavity in the battery accommodating cavity.

2. The flash device system according to claim 1, wherein the cavity locking protruding element and/or the cavity locking cavity arranged on the battery comprise a spring loaded push button.

3. The flash device system according to claim 1, wherein the battery locking protruding element and/or the battery locking cavity in the battery accommodating cavity comprise a spring loaded push button.

4. The flash device system according to claim 1, wherein an exterior surface of the battery forms an exterior surface of the flash holder when the battery is arranged in the battery accommodating cavity.

5. The flash device system according to claim 1, wherein two of the electric contacts of the battery are arranged to switch on the battery when put in contact with the corresponding electric contacts of the battery accommodating cavity.

6. The flash device system according to claim 1, wherein the electric contacts of the battery are arranged to be put in contact with the corresponding electric contacts of the battery accommodating cavity at the moment when the battery is locked into the battery accommodating cavity.

7. The flash device system according to claim 1, wherein the battery is of Lithium-ion type.

8. A flash device for photographic purposes comprising:
a flash holder having a battery accommodating cavity formed therein; and
a flash housing hinged onto the flash holder;
wherein the battery accommodating cavity comprises:
electrical access contacts;
a battery locking protruding element; and
a battery locking cavity,
wherein the battery locking protruding element and the battery locking cavity are arranged on opposite inner side walls of the battery accommodating cavity.

9. The flash device according to claim 8, wherein the battery locking protruding element and/or the battery locking cavity of the battery accommodating cavity comprise a spring loaded push button.

10. The flash device according to claim 8, wherein two of the electric contacts of the battery accommodating cavity are arranged to switch on a battery placed in the battery accommodating cavity when put in contact with corresponding electric contacts of the battery.

11. The flash device according to claim 8, wherein two of the electric contacts of the battery accommodating cavity are arranged to switch on a battery placed in the battery accommodating cavity when put in contact with corresponding electric contacts of the battery at the moment when the battery is locked into the battery locking cavity.

12. A battery for a flash device for photographic purposes comprising:
electric contacts; and
a cavity locking protruding element and a cavity locking cavity for engagement with a corresponding battery locking protruding element and battery locking cavity in a battery accommodating cavity,
wherein two of the electric contacts of the battery are arranged to switch on the battery when put in contact with corresponding electric contacts of a battery accommodating cavity.

13. The battery according to claim 12, wherein the battery locking protruding element and/or the battery locking cavity element comprises a spring loaded push button.

14. The battery according to claim 12, wherein two of the electric contacts of the battery are arranged to switch on the battery when put in contact with the corresponding electric contacts of a battery accommodating cavity at the moment when the battery is locked into the battery accommodating cavity.

15. The battery according to claim 12, wherein the battery is of Lithium-ion type.

16. A battery charger for a battery for a flash device for photographic purposes comprising:
a battery accommodating cavity comprising:
electric access contacts; and
a battery locking protruding element and a battery locking cavity for engagement with a corresponding cavity locking protruding element and cavity locking cavity on a battery, wherein the battery locking protruding element and the battery locking cavity are arranged on opposite inner side walls of the battery accommodating cavity,
wherein two of the electric contacts of the battery accommodating cavity are arranged to switch on a battery placed in the battery accommodating cavity when put in contact with the corresponding electric contacts of the battery.

17. The battery charger according to claim 16, wherein the battery locking protruding element and/or the battery locking cavity element comprises a spring loaded push button.

18. The battery charger according to claim 16, wherein two of the electric access contacts of the battery accommodating cavity are arranged to switch on a battery placed in the battery accommodating cavity when put in contact with the corresponding electric contacts of the battery at the moment when the battery is locked into the battery accommodating cavity.
